(19) United States
(12) Patent Application Publication
(10) Pub. No.: US 2014/0091108 A1
(43) Pub. Date: Apr. 3, 2014

(54) SYSTEM AND METHOD OF TREATING A DRAIN

(71) Applicants: Eric Sternberg, Wantagh, NY (US); Randy Kaplan, Huntington, NY (US); Mathew Sternberg, Seaford, NY (US)

(72) Inventors: Eric Sternberg, Wantagh, NY (US); Randy Kaplan, Huntington, NY (US); Mathew Sternberg, Seaford, NY (US)

(21) Appl. No.: 13/631,016

(22) Filed: Sep. 28, 2012

(51) Int. Cl. B67D 7/06; B65D 37/00

(52) U.S. Cl. 222/205; 206/525; 222/211

(57) ABSTRACT

The invention is a system and method of unclogging and maintaining a drain or conduits that deliver fluids such as water. The system includes delivering a predetermined amount of drain cleaner to an obstruction wherein the predetermined amount may be delivered by a single-use packet or by a receptacle that is capable of premeasuring a single application. The system and or packet may also be used to disperse a composition over a period of time as maintenance of a drain or conduit.

### A. CROSS REFERENCE TO RELATED APPLICATIONS

This application claims benefit pursuant to 35 U.S.C. §119(e) of Provisional Application Ser. No. 61/540,506 filed Sep. 28, 2011, the disclosure of which is incorporated herein by reference in its entirety.

### I. BACKGROUND

B. Field of Invention

The present invention relates to fluid-pipe delivery and plumbing systems, in particular, the invention relates to a system and method of treating conduits including unclogging of drains.

C. Description of the Related Art

Passageways, including drains and conduits typically become clogged or non-functional as a result of the accumulation of objects over time or in an instance where too many objects are forced through a path and lodge. Sometimes a clog may be formed by a single object. Sometimes an obstruction may be cause by mold, mildew, or water minerals that forms a barrier in an underused or overused passageway. In other instances, an infestation of pests may further lead to obstruction.

Whatever circumstances surround an obstruction, it is necessary for the passage(s) to be cleared so operation of a machine or other function dependent on the conduit may perform properly and efficiently. Some machines or other functions that rely upon and or relate to conduits are for example, toilets, sinks, reservoirs, washing machines, and corresponding drains therein, and other appliances, not limited to commercial, industrial and residential environments.

Generally an obstruction is relieved by use of a plunger-type mechanism, a plumbing snake or chemicals. A plunger-type mechanism is generally used by a broad range of users that include individual's first effort based on the convenience, supply, and simplicity of the plunger. The plumbing snake is typically an instrument use by professionals whereby a line is introduced into a conduit and the operator forces the line to break and or pass through an obstruction. Chemicals have both commercial and domestic applications. Typically a user dispenses an amount of a chemical into a drain and the chemical reacts and dissolves the material.

The plunger is not always effective and may be laborious. Furthermore, a plunger can produce an unsanitary atmosphere. Special care needs to be taken to make sure waste does not escape a toilet, for example. And, it is important to make sure that a plunger is always clean and sanitized, especially when transitioning from a toilet for example to a kitchen sink.

A plumbing snake is a comparably large and bulky machine that may be labor intensive and require training as well as sufficient storage space. While the plumbing snake may be more effective than a plunger in certain instances, it too must always be clean and sanitized. Also, different size snakes may be required for different circumstances as all lines cannot penetrate all conduits, for example, a line that would penetrate a toilet may not necessarily fit a kitchen drain.

Chemicals provide the benefit of avoiding the need to maintain and sanitize a tool and do not necessarily require much labor. Unfortunately drawbacks associated with chemicals are that a general user and or consumer may not know an appreciable range of chemical necessary to cure an obstruction in a sink or toilet for example, leading to excessive overuse. Over time, overuse may lead to premature corrosion of pipes and require costly replacements.

Therefore, there is a need to have an effective option to clean conduits that is not labor intensive, does not require cleaning and or maintenance, and reduces suffering of pipes and costly repairs.

### II. SUMMARY

The current invention is a delivery system and method for unclogging a conduit and or passageways, and not limited to environments having a drain, that allows an operator to successfully clean a drain or conduit in a sanitary environment without labor or undue burden on pipe integrity.

An embodiment of the invention is a container that comprises a predetermined and or premeasured amount of composition or unclogging product necessary to clear and or unclog a drain or conduit. In use, the predetermined amount is delivered into a clogged system, such as a pool or aggregate formed as result of an obstruction or clog, upon which the composition reacts therein and relieves the obstruction.

An embodiment of the invention includes a single use packet having a predetermined amount of composition necessary to unclog a drain or conduit, whereby the container is directly introduced to a fluid aggregate, and contents therein are delivered in a single instance or upon discrete amounts or intervals as a result of the dissolvability of the container or chambers.

Another embodiment of the invention includes a receptacle that contains a single use container, and or containers, such that the receptacle may be used as a reservoir for dissolving composition of container therein and is then used to deliver or introduce slurry to an aggregate. Additionally, it is an embodiment of the invention to introduce a spout directly into the receptacle such that the dissolved single use slurry may unclog a spout or other conduit portion submerged therein.

Another embodiment of the present invention includes a first receptacle that communicates with a second receptacle such that a predetermined or premeasured amount of composition may transfer from the first receptacle to the second receptacle. The contents of which can thereafter be introduced to clear a conduit while remaining composition remains stored in first receptacle.

A further embodiment of the invention is delivering a container containing composition into a site within and or about a conduit such that delivery of composition to an obstruction is made and or triggered when a conduit is clogged and back up initiates delivery of composition by dissolving container for example.

### III. BRIEF DESCRIPTION OF THE DRAWINGS

The invention may take physical form in certain parts and arrangement of parts, some embodiments of which will be described in the specification and illustrated in accompanying drawings which form a part hereof, wherein:

FIG. 1 is a perspective view of an embodiment of a container that shows for example how composition may be accessed;

FIG. 2 is a perspective view of an embodiment of a container that has a portion which dissolves;

FIG. 3 is a perspective view of an embodiment of a container that has sub chambers that dissolve at different rates and provides a timed release or delay;

FIG. 4 a perspective view of a receptacle showing an embodiment where a spout may be inserted into the receptacle;

FIG. 5A is a perspective view of an embodiment of a conduit that shows an embodiment where a packet A or B may be used in an overflow;

FIG. 5B is a perspective view of an embodiment of a conduit that shows an embodiment where a packet C may be used in an overflow;

FIG. 6 is a perspective view of an embodiment of a delivery system that has two communicating receptacles whereby a first receptacle delivers a single use or predetermined amount of composition to a second receptacle; and

FIG. 7 is a perspective view of another embodiment of how a first receptacle and second receptacle according to the instant invention.

### IV. DETAILED DESCRIPTION OF THE INVENTION

The current invention is a delivery system and method for displacing an obstruction in a conduit such as a drain, pipe, or other passageway. An embodiment of the invention comprises a container 10 that has a chamber 15 surrounding a pre-measured or pre-determined amount of a composition 20 necessary to displace an obstruction in a conduit and or unclog a drain.

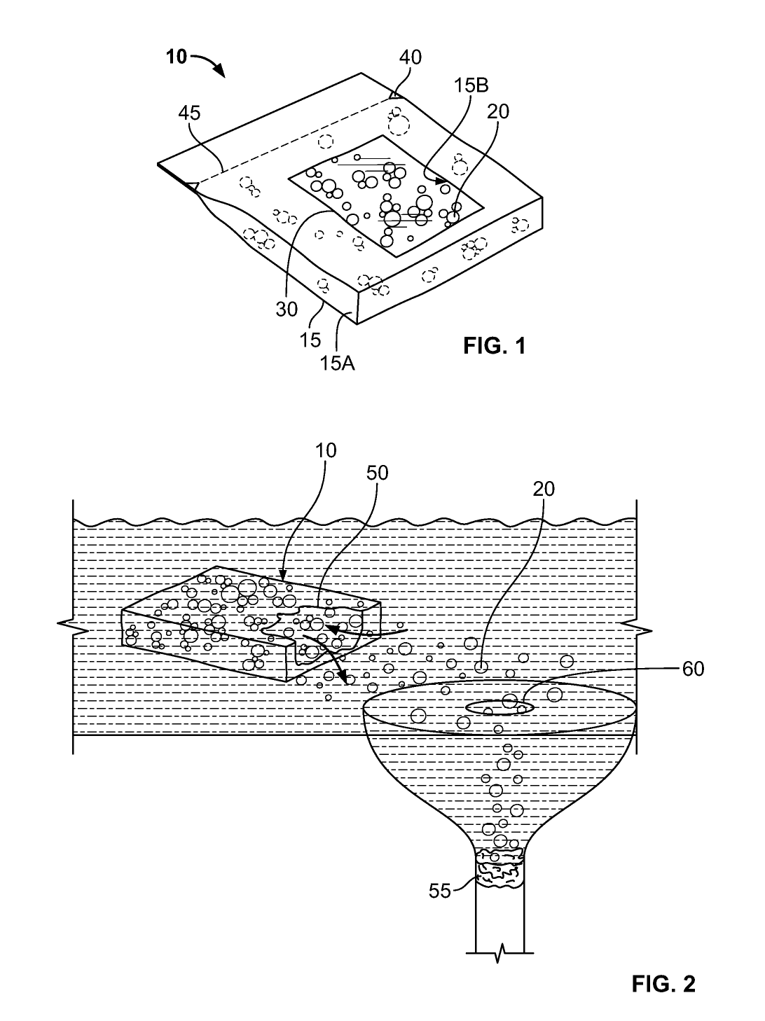

As shown in FIG. 1, an embodiment of a container 10 may include a single-use article such as a pack, packet or some other porting device that has an outer wall 15A and an inner wall 15B, the combination of which may form single wall of chamber 15 having two sides (aka an interior and an exterior) wherein it is considered that the single wall surrounds composition 20 located in the interior of chamber 15.

Packet 10, for example, may be formed of any material that will be inert and or unreactive to composition 20 contained therein as well as inert to ambient conditions as to not affect composition. As shown in FIG. 1, in an embodiment, a portion of packet 10 is clear so that contents 20 may be visible through window 30, so that the composition 20 may be determined without obstructing wall 15. It is understood however that the entire packet 10 and or wall 15 (i.e., 15A and 15B) may be clear so that contents 20 are visible at all views. A further embodiment includes instance whence wall 15 is used to identify contents such as composition 20 and strength for example which can be identified by coloring of wall or composition, labeling therein, or other-type insignia or identification known. A further embodiment includes such instance where wall is opaque.

Although FIG. 1 shows an embodiment of a packet 10 that is rectangular, container 10 may include other geometrical forms and structures known for containing, holding, transporting, and or delivering a product and not limited to structures including those associated with forms and objects not limited to a bag, a disk, a rectangle, a ball, and the like wherein the forms and objects may contain a single wall or single side, or even several sides or walls.

The composition 20 within container 10 may be any suitable material such as a chemical composition that is known to clear drains, treat sewage, treat pipes, or interact in any other manner known in the field that relates to a substance being transported through a conduit for treating, interacting, carrying or transporting therein.

The form of composition 20 may be liquid or solid, wherein when in the solid state, it may include form not limited to granules, pellets, or other known forms. Notwithstanding, it is necessary that the amount of composition 20 in chamber 15 or contained in packet 10 be an amount minimally sufficient to displace an obstruction, i.e., extricate a conduit so that unnecessary over use of a harmful chemical or other product is avoided. While a single-use application may be generally acceptable, some instances may require an additional container packet, in which case a second or third container, etc., may be used. Furthermore, it is an embodiment of the invention to have different volume container packets that may be required for applications which can be known to require more than one application.

Composition 20 may be released and or dispensed from container 10 though communicating displaced portions of chamber walls 15A and 15B. As mentioned this may also be referred to as displacing a single wall of chamber 15 having two sides. The displacement may be made through physical means not limited to a tab, a tear, perforation, a peel away portion, a puncture portion, or other similar like engagements. FIG. 1 shows the embodiment where tear 40 may be united with a perforation 45, for example.

Another embodiment of the invention includes dispensing predetermined amount of composition 20 by displacing chamber wall through chemical means that includes dissolving a portion of outer wall 15A and a communicating portion of inner wall 15B.

FIG. 2 is a perspective view of an embodiment of container 10 that has a portion 50 which dissolves. As shown, when portion 50 of container 10 dissolves fluid or ambient matter may enter container 10 and react and or dissolve composition 20 and or force composition 20 out of container 10 so it may effectively pass through a conduit or drain 60 for example and displace an obstruction 55. It is an embodiment of the invention wherein the dissolving portion 50 includes the dissolving of the entire container 10, such that the entire container 50 dissolves. It is yet another embodiment of the invention to have outer wall 15A and the inner wall 15B selectively pervious and or fluctuate in thickness and or dissolvability to control the rate of release of composition 20 from container 10 in either circumstance when walls comprise dissolving portion 50 which may include entire container 10.

As may be understood, some clogged systems may require a larger amount of a predetermined amount of composition 20 or require dispensing of predetermined amount of composition 20 over an extended period of time. In which case, it may be preferred to use a container 10 that has multiple chambers.

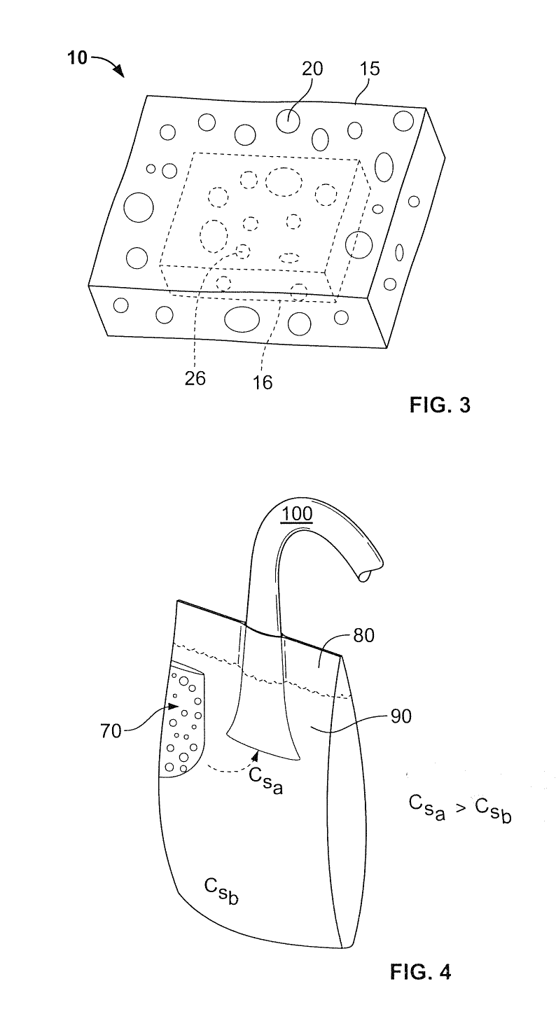

FIG. 3 is a perspective view of an embodiment of a container 10 that has two chambers 15 and 16 that may dissolve at different rates and provide a timed release or delay. As shown, a first chamber 15 contains a premeasured amount of composition 20 and surrounds a second chamber 16 containing a predetermined amount of composition 26. As can be understood, upon a portion of chamber wall 15 dissolving, fluid may enter chamber 15 and allow composition 20 to escape chamber 15 wherein same fluid may further begin to dissolve inner chamber 16, wherein which upon dissolving a potion therein shall allow composition 26 to escape chamber 16 and chamber 15, resulting in a timed release of a predetermined amount of composition 20 and 26.

As can be appreciated by the invention, there may be numerous chambers in a container depending on the amount of timed release desired. Furthermore, it is an embodiment of the invention to have walls and or boundaries of chamber(s) fluctuate in thickness and or dissolvability to further control rate of release. It is a further embodiment of the invention for chambers to contain different compositions that may release different composition at same time or different times depending on the circumstance. For example, as in FIG. 3, chamber 15 may contain may contain a pretreatment 20 that is administered to protect a drain or passageways from the subsequent delivered premeasured composition 26 that has an unclogging element. Along the same lines, an additional chamber may be contained within 15 that release a composition that conditions conduits or that treats a septic tank, either before, after or during the time when a composition 26 disperses, and so on.

Notwithstanding, once an obstruction is displaced and a drain is unclogged for example, there may be composition remaining in an unused chamber in the event for example a user accidentally overuses the product. It is therefore a further embodiment of the invention that the remaining contents be stored in a receptacle so as to not introduce into environment as waste or garbage.

An embodiment of the storage 70 includes it being shaped and sized to resemble a pre-measured quantity amount, such that when the storage 70 is filled, it contains a same amount that is a predetermined single-use dose. Additionally, storage 70 may be pervious to liquid such that when sufficient liquid 90 is introduced to receptacle 80, the composition stored at 70 may dissolve or dilute in storage 70 within receptacle 80 and be poured into a an aggregate pool to release a drain for example. In another embodiment a clogged spout may be submerged into receptacle 80 so that composition 20 may displace obstructions therein. FIG. 4 is a perspective view of an embodiment showing a portion of spout 100 submerged in receptacle 90. As a result of having source of the composition 20 closer to the area of spout 100 where an obstruction may be present, better results may be achieved because the concentration of the composition in fluid 90 near spout 100 Csₐ may be greater than the concentration of the composition at the base of receptacle 90 Cs_{b}, as indicated.

A further embodiment of the invention is introducing a predetermined single use packet into a conduit such that the container and or its contents therein only becomes accessed or used when a system is blocked.

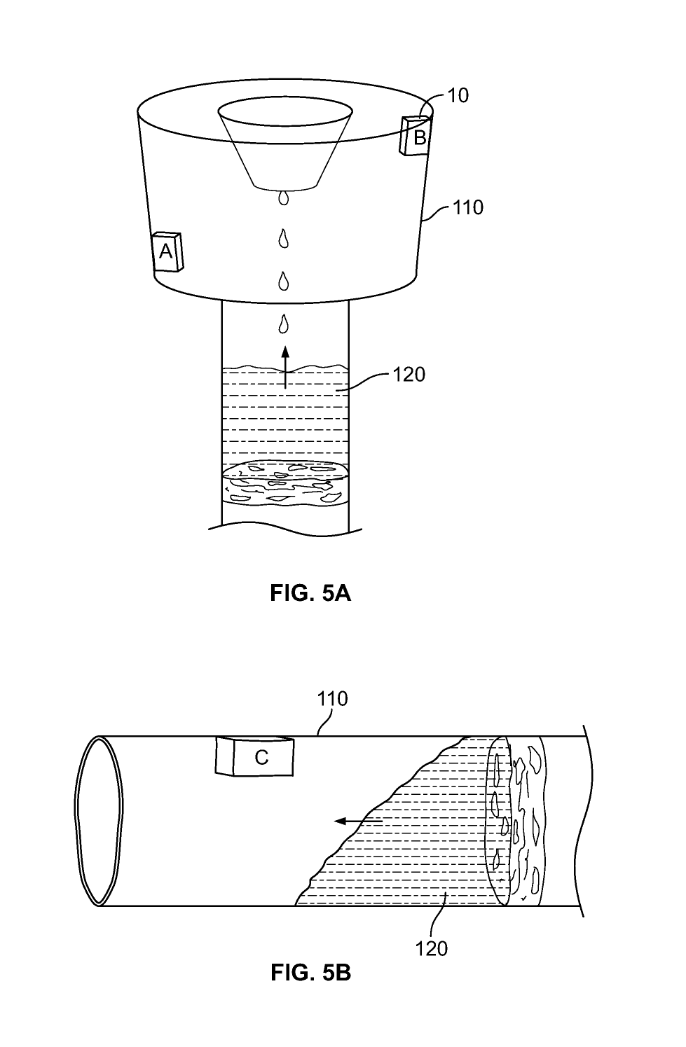

FIGS. 5A and 5B show a perspective of embodiments of container A, B, C located in different regions of conduit 110 where a container 10 may advantageously be placed to remain dry until an overflow or clog is experienced. The container 10 may be placed in other locations and may be further combined and or attached within a conduit by an adhesive clip or any other known means of attaching a suitable container to a conduit 110 wall therein. In an embodiment, a packet 10 may be inserted about a dry internal region of a drain, for example, such that when an obstruction causes accumulation of fluid, the container lining comes into contact with the fluid which causes the packet to dissolve and release and or deliver the single use contents. In this embodiment, the single use or predetermined amount of product is delivered automatically, without need of a user.

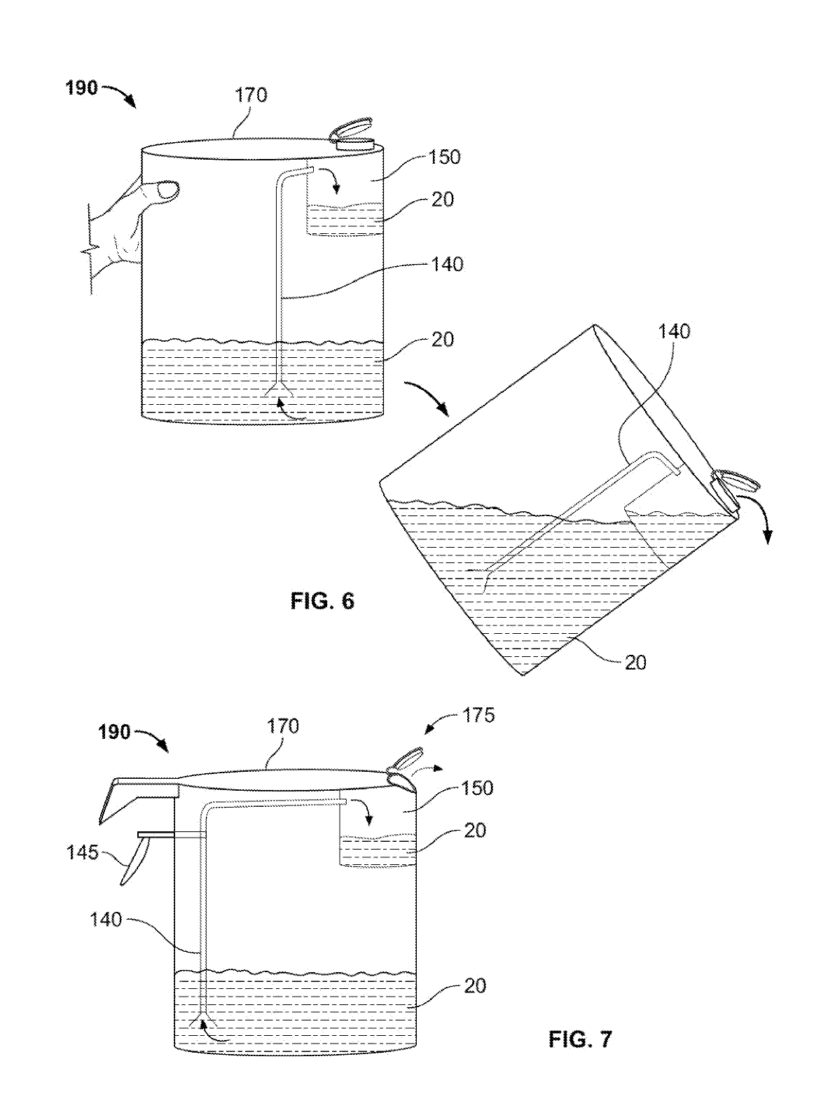

FIG. 6 shows another embodiment of the invention whereby a drain cleaning delivery system 190 comprises a first receptacle 170 that is capable of storing a composition 20, whereby when the first receptacle 170 stores composition 20, a measured portion of composition 20 is capable of being displaced such that the first receptacle 170 transfers said portion of composition to a second receptacle 150. The embodiment of the invention discloses another delivery of a premeasured amount of a composition.

As shown in FIG. 6, composition 20 may be displaced for example by squeezing first receptacle 170 as shown by the hand. Effectively, this would force composition 20 through tube 14 which would empty into second receptacle 150 as shown. It is an embodiment that the second receptacle 150 can be self-regulating such that the amount of composition that enters and or is maintained in second receptacle 150 is pre-determined amount that is minimally sufficient to use as a single application to clear a drain.

Once a sufficient amount of composition 20 enters into second receptacle 150, the premeasured amount may thereafter be delivered to an area, such as a clogged sink, for example. Additionally, the second receptacle may have a stop 175 as shown in FIG. 7, which also shows another embodiment of a drain cleaning delivery system. Stop 175 may include a pull, twist, pop, one-way valve and other known exit orifice means. It is understood that a predetermined about of composition may be delivered from first receptacle 170 to second receptacle 150 by other displacing and or delivery means, such as inverting the receptacles or utilizing an automated procedure that ensures second receptacle remains full, and so on. In the embodiment shown in FIG. 7 however, composition 20 may be displaced by use of a trigger 145 that assists with transfer of composition 20 from first receptacle 170 to second receptacle 150. Notwithstanding, it is within the scope of the invention that receptacle 170 can deliver a single premeasured amount of composition 20 without a second receptacle intermediary step.

Various changes and modifications may be made without departing from the spirit and scope of the Invention and it is intended that such obvious changes and modifications be embraced by the annexed claims.

Having thus described the invention, what is claimed as new and desired to be secured by Letters Patent is:

1. A container for use in treating an obstructed conduit comprising a chamber that surrounds a composition capable of interacting with an obstruction.

2. The container of claim 1, wherein a portion of the chamber is capable of being displaced so that composition is released from the container at a rate sufficient to interact with an obstruction and clear a conduit.

3. The container of claim 1, wherein a portion of the chamber is selectively pervious.

4. The container of claim 3, wherein said selectivity of the chamber provides composition to release from container at a rate sufficient to displace an obstruction.

5. The container of claim 4, wherein the chamber has a series of portions selectively pervious, such that said composition may release at a rate sufficient to displace an obstruction.

6. The container of claim 1, whereby the container comprises multiple chambers surrounding a composition that are arranged in a series such that the chambers release said composition from the container at different rates.

7. The container of claim 6, whereby the composition in multiple chambers is altered depending on the obstruction.

8. A single-use packet for unclogging drains comprising an outer wall and an inner wall, wherein the inner wall surrounds a pre-measured portion of a composition that is in a quantity sufficient to unclog a drain.

9. The single-use packet of claim 8, wherein the composition is released from the packet though communicating displaced portions of the walls.

10. The single-use packet of claim 9, wherein displacement is caused by chemical means.

11. The single-use packet of claim 10, wherein displacement is caused by physical means.

12. The single-use packet of claim 10, wherein a portion of the outer wall is displaced by physical means and a portion of the inner wall is displaced by chemical means.

13. A method of delivering a predetermined amount of drain cleaning composition comprising the steps of transferring a predetermined amount of composition to a first receptacle and said receptacle may thereafter deliver said pre-measured portion of composition to the site of an obstruction.

14. The method of claim 13 wherein the first receptacle is a packet.

15. The method of claim 13 wherein the predetermined amount of the first receptacle is an amount sufficient to deliver multiple uses.

16. The method of claim 15 that includes the step of transferring a second predetermined amount of composition from said first receptacle to a second receptacle such that the amount contained in the second receptacle is an amount sufficient to clear a conduit in about a single application.

17. The method of claim 13 wherein the site of the obstruction is in proximity to an obstruction such that when the obstruction causes a clog, the premeasured portion is thereinafter delivered.
